(19) United States
(12) Patent Application Publication
(10) Pub. No.: US 2020/0358648 A1
(43) Pub. Date: Nov. 12, 2020

(54) CONTINUOUS MONITORING OF NETWORK DEVICES DURING MAINTENANCE

(71) Applicant: Cisco Technology, Inc., San Jose, CA (US)

(72) Inventors: Krishna Reddy Somala, San Ramon, CA (US); Sanshit Sharma, Milpitas, CA (US); Ryan Rozanski, San Jose, CA (US); Selvakumaran N. Subramanian, Pleasanton, CA (US); Nitish Vashishtha, San Jose, CA (US)

(21) Appl. No.: 16/662,857

(22) Filed: Oct. 24, 2019

Related U.S. Application Data
(60) Provisional application No. 62/844,998, filed on May 8, 2019.
(60) Provisional application No. 62/846,905, filed on May 13, 2019.

(51) Int. Cl. H04L 12/24; H04L 12/26

(52) U.S. Cl. CPC H04L 41/0672; H04L 41/0886; H04L 41/082; H04L 43/0817

(57) ABSTRACT

Presented herein are embodiments for performing maintenance on devices in a network. A plurality of maintenance operations are generated that are to be executed on a plurality of network devices in a network. Instructions are transmitted to the plurality of network devices to execute one or more maintenance operations of the plurality of maintenance operations. Continuous checks are performed on the execution of the one or more maintenance operations by analyzing telemetry data that is received from the plurality of network devices. In response to an indication of a network device failing a criterion of a continuous check, one or more corrective actions are automatically performed.

### PRIORITY CLAIM

This application claims priority to U.S. Provisional Application No. 62/844,998, filed May 8, 2019, and to U.S. Provisional Application No. 62/846,905, filed May 13, 2019. The entirety of each of these applications is incorporated herein by reference.

### TECHNICAL FIELD

The present disclosure relates to managing network devices, and more specifically, to the continuous monitoring of network devices while executing maintenance operations.

### BACKGROUND

In the field of networking, the states of all devices in a network are maintained from time to time. While maintenance solutions are available, there is room for improvement by enabling the use of automation solutions. Current automation solutions may not be able to run checks in the background while configuration tasks are being performed on the devices in the network. Further, there are other challenges, such as the ability to monitor other parts of a network that should be unaffected by current configuration activities, but may nevertheless experience negative consequences due to such activities.

### BRIEF DESCRIPTION OF THE DRAWINGS

FIG. 1 is a block diagram depicting a network environment for performing maintenance operations on network devices, in accordance with an example embodiment.

FIG. 2 is a flow chart depicting a method of performing maintenance operations on network devices, in accordance with an example embodiment.

FIG. 3 is a flow chart depicting a method of monitoring network devices, in accordance with an example embodiment.

FIG. 4 is a block diagram depicting an operational flow for monitoring network devices, in accordance with an example embodiment.

FIG. 5 is a diagram depicting a user interface for performing continuous monitoring, in accordance with an example embodiment.

FIG. 6 is a diagram depicting a user interface for a monitoring overview, in accordance with an example embodiment.

FIG. 7 is a flow chart depicting a method of scheduling maintenance operations for network devices, in accordance with an example embodiment.

FIGS. 8A-8D are diagrams depicting user interfaces for scheduling maintenance operations for network devices, in accordance with an example embodiment.

FIG. 9 is a block diagram depicting an orchestrator flow, in accordance with an example embodiment.

FIG. 10 is a block diagram depicting pre-maintenance and maintenance state machines, in accordance with an example embodiment.

FIG. 11 is a block diagram depicting a computing device configured to perform the methods presented herein, in accordance with an example embodiment.

### DESCRIPTION OF EXAMPLE EMBODIMENTS

### Overview

In one embodiment, a solution is provided for performing maintenance on devices in a network. A plurality of maintenance operations are generated that are to be executed on a plurality of network devices in a network. Instructions are transmitted to the plurality of network devices to execute one or more maintenance operations of the plurality of maintenance operations. Continuous checks are performed on the execution of the one or more maintenance operations by analyzing telemetry data that is received from the plurality of network devices. In response to an indication of a network device failing a criterion of a continuous check, one or more corrective actions are automatically performed.

### Example Embodiments

The present disclosure relates to managing network devices, and more specifically, to the continuous monitoring of network devices while performing maintenance operations, such as repairs, upgrades, downgrades, and any other modifications or configuration changes to the software of devices. Embodiments presented herein leverage multiple data sources to perform checks and validations, including telemetry data that uses the Simple Network Management Protocol (SNMP) protocol, a Common Layer Interface (CLI) format, and any other telemetry protocol or format. Checks and validations may be executed continuously in the background while maintenance operations are executed. Moreover, devices and networks may be monitored to ensure that the maintenance being performed does not have any unintended side-effects. An operator may categorize tasks into continuous phases that run in the background for the duration of execution of a method of procedure (MOP). A MOP is a step-by-step sequence of all maintenance operations to be performed for a particular maintenance job. A configuration engine enables users to schedule continuous checks to start prior to maintenance operations, which may also be scheduled in advance. The configuration engine may run all continuous checks concurrently and constantly for the duration of MOP execution, and may enable users to define pass and fail criteria as well as custom check verbs.

In presented embodiments, monitoring tasks may run continuously in the background to ensure that maintenance tasks do not cause unintended side effects in network devices and/or networks themselves. Embodiments presented herein enable the scheduling of checks so that checks are started prior to maintenance tasks, thereby ensuring that a network is stable before any configuration changes are made. Moreover, by initiating monitoring prior to execution of a maintenance task, unintentional configuration changes may not be performed while the maintenance task is executed. This solution enables a user to specify pass and fail criteria by defining a number of consecutive successful iterations of continuous checks.

Moreover, present embodiments relate to monitoring and maintaining network devices, and more specifically, to an automation engine with custom scheduling of methods of procedures. An operator may schedule execution of playbooks, which include methods of procedures for particular maintenance operations. The operator may specify start times for pre-maintenance and maintenance tasks, which can be run separately. Multiple iterations of maintenance operations may be performed to ensure that a network device is in a stable state before configuration changes are deployed to the device. Pre-checks may be performed concurrently, and the pass and fail criteria for each check may be user-configurable. Moreover, multiple data collection mechanisms are supported, including model driven telemetry and Simple Network Management Protocol (SNMP) telemetry.

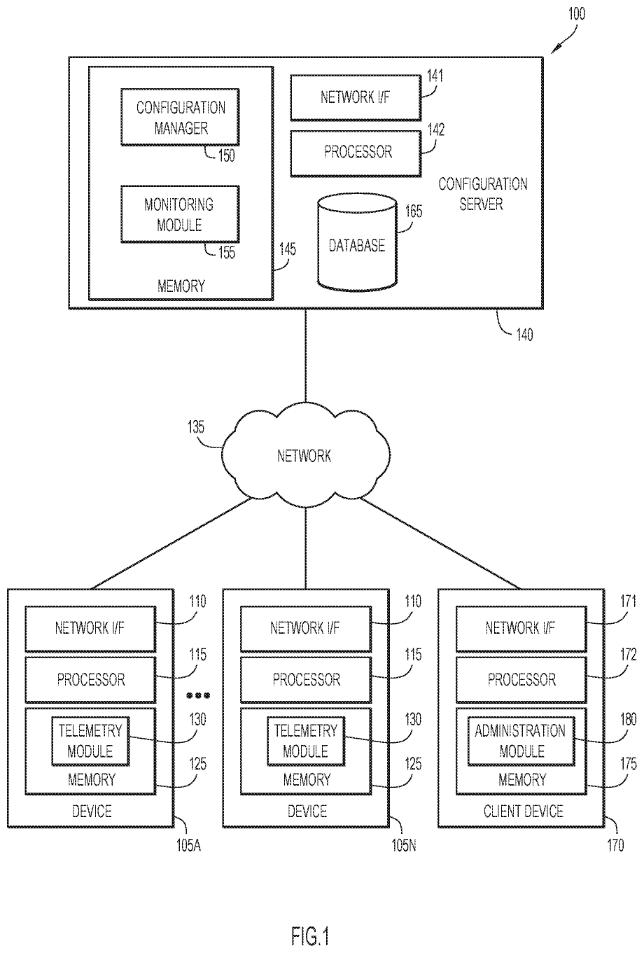

Embodiments are now described in detail with reference to the figures. FIG. 1 is a block diagram depicting a network environment 100 for configuring network devices, in accordance with an example embodiment. As depicted, network environment 100 includes a plurality of devices 105A-105N, a network 135, a configuration server 140, and a client device 170. It is to be understood that the functional division among components of network environment 100 have been chosen for purposes of explaining the embodiments and is not to be construed as a limiting example.

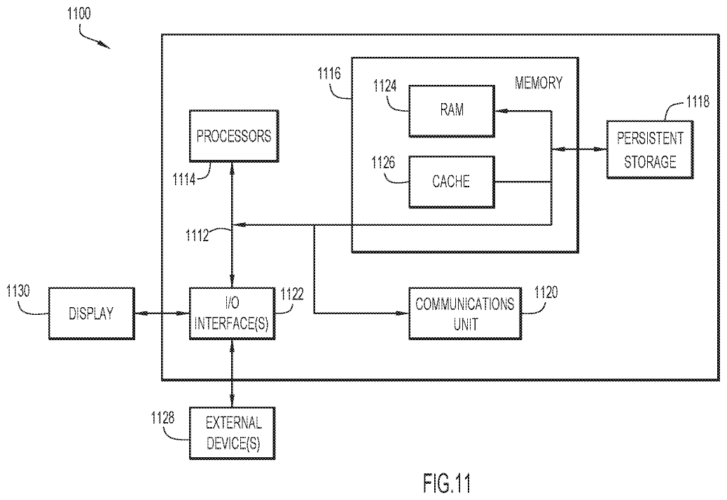

Each device 105A-105N includes a network interface (I/F) 110, a processor 115, and memory 125. The memory 125 stores software instructions for telemetry module 130, as well as various other data involved in operations performed by the processor 115. In various embodiments, devices 105A-105N may include any programmable electronic device capable of executing computer readable program instructions. Devices 105A-105N may thus include any network devices that typically include line cards, such as devices that perform switching, routing, firewall or other network functions. In various embodiments, devices 105A-105N may include one or more of switches, routers, gateways, repeaters, access points, traffic classifiers, and the like. Each device 105A-105N may include internal and external hardware components, such as those depicted and described in further detail with respect to FIG. 11.

Telemetry module 130 may collect data relating to a device's health and performance and transmit the collected data to one or more network-accessible recipients, such as configuration server 140. Telemetry module 130 may collect data corresponding to any data type, format, or protocol, including telemetry data that follows a Yet Another Next Generation (YANG) model, telemetry data that correspond to a Simple Network Management Protocol (SNMP) protocol, a Common Layer Interface (CLI) format, and/or any other format.

Network 135 may include a local area network (LAN), a wide area network (WAN) such as the Internet, or a combination thereof, and includes wired, wireless, or fiber optic connections. In general, network 135 can use any combination of connections and protocols that support communications between devices 105A-105N, configuration server 140, and/or client device 170 via their respective network interfaces.

Configuration server 140 includes a network interface (I/F) 141, a processor 142, memory 145, and a database 165. The memory 145 stores software instructions for a configuration manager 150 and a monitoring module 155, as well as various other data involved in operations performed by the processor 142. In various embodiments, configuration server 140 may include any programmable electronic device capable of executing computer readable program instructions. Configuration server 140 may include internal and external hardware components, as depicted and described in further detail with respect to FIG. 11.

Configuration manager 150 and monitoring module 155 may include one or more modules or units to perform various functions of the embodiments described below. Configuration manager 150 and monitoring module 155 may be implemented by any combination of any quantity of software (and/or hardware modules or units), and may reside within memory 145 of configuration server 140 for execution by a processor, such as processor 142.

Configuration manager 150 may enable a network operator to add, remove, and edit methods of procedure, which include operations that can be executed on devices 105A-105N to perform maintenance. Configuration manager 150 may transmit maintenance operations to devices for execution. When configuration manager 150 receives instructions from an operator (e.g., via administration module 180 of client device 170), maintenance instructions may be transmitted to one or more devices (e.g., devices 105A-105N) and executed locally on the devices.

Each method of procedure may contain instructions to update or otherwise modify instructions on one or more network devices, such as devices 105A-105N. The instructions of a method of procedure may include maintenance operations, which can be categorized as operations that perform pre-maintenance tasks, and operations that perform maintenance tasks. Pre-maintenance tasks can include any tasks that prepare a device for maintenance, such as determining whether there is enough available storage space on a device to receive an update, determining that a device is compatible with an update and that the device is stable, and other non-disruptive behaviors. Pre-maintenance tasks may be performed on a device while the device remains in operation (e.g. while a device continues to fulfill its role in handling network traffic). In contrast, maintenance tasks may require that a device is placed in a maintenance mode in which the device remains powered on and is capable of executing operations, but does not handle network traffic. Maintenance tasks may be performed only when a device successfully passes pre-maintenance tasks, and may include substantive changes to the device that are part of the overall maintenance process, such as upgrading, downgrading, or otherwise modifying the device's software and/or firmware. Configuration manager 150 may utilize a method of procedure to generate a playbook, which is an automated process or script for deploying the method of procedure (e.g., executing, on specific devices, the maintenance operations of the method of procedure).

Configuration manager 150 may control pre-maintenance, maintenance, and post-maintenance phases of maintenance jobs on network devices (e.g., devices 105A-105N) according to a predefined schedule. Moreover, configuration manager 150 may, via monitoring module 155, perform checks at each phase, and a maintenance operation may not advance to a next step if a check is not passed. An operator may provide configuration details to configuration manager 150 via administration module 180 of client device 170. In particular, an operator may define pass and fail criteria for checks. Configuration manager 150 may provide check verbs for pre-maintenance and post-maintenance validations, which can be performed in-line during execution of maintenance operations. Check verbs may support multiple data collection mechanisms, such as model-driven telemetry and SNMP telemetry. An operator may specify a preferred collection type at runtime.

Monitoring module 155 may execute monitoring operations during maintenance tasks. An operator may provide instructions for monitoring module 155 to schedule one or more monitoring operations that run continuously until maintenance operation are finished. Monitoring module 155 may perform continuous checks by analyzing data received from devices 105A-105N, including devices that are executing maintenance operations, as well as any devices that should be unaffected (but may nevertheless be affected) by the current maintenance operations. An operator may access monitoring module 155 via administration module 180 of client device 170. In some embodiments, an operator can define custom check verbs as well as pass and fail criteria for each maintenance operation, which can based on a number of consecutive successful iterations of continuous checks. Upon identification of a failure, one or more corrective action may be automatically performed. Corrective actions may include rolling back a device's software or firmware to a previous version or state, completing maintenance operations to result in a partially completed method of procedure, pausing execution of a method of procedure and alerting an operator of a failure, and the like.

Database 165 may include any non-volatile storage media known in the art. For example, database 165 can be implemented with a tape library, optical library, one or more independent hard disk drives, or multiple hard disk drives in a redundant array of independent disks (RAID). Similarly, data in database 165 may conform to any suitable storage architecture known in the art, such as a file, a relational database, an object-oriented database, and/or one or more tables. Database 165 may store data such as stock or custom playbooks and methods of procedure, identifiers and network paths of devices 105A-105N registered with configuration server 140, historical telemetry data (e.g., time series data), and the like.

Client device 170 includes a network interface 171, at least one processor 172, and memory 175 with an administration module 180. In various embodiments, client device 170 may include any programmable electronic device capable of executing computer readable program instructions. Network interface 171 may include one or more network interface cards that enable components of client device 170 to send and receive data over a network, such as network 135. Client device 170 may include internal and external hardware components, such as those depicted and described in further detail with respect to FIG. 11.

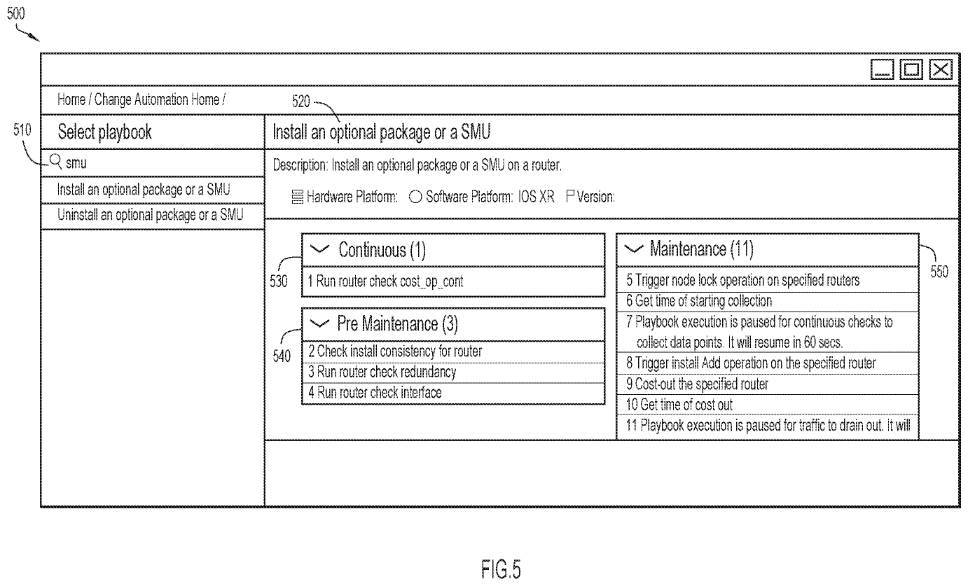

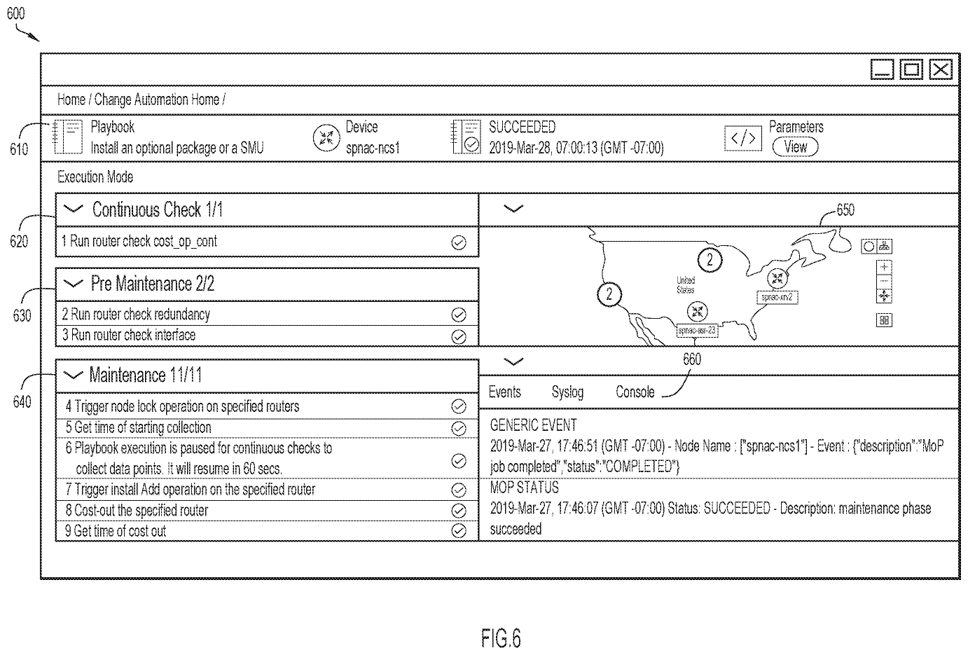

Administration module 180 may enable a user of client device 170, such as network operator, to provide input to configuration manager 150 and monitoring module 155 to manage network maintenance and monitoring tasks. A user of client device 170 may manage configurations of devices using a user interface, such as the user interface that is depicted and described in further detail below with respect to FIGS. 5 and 6.

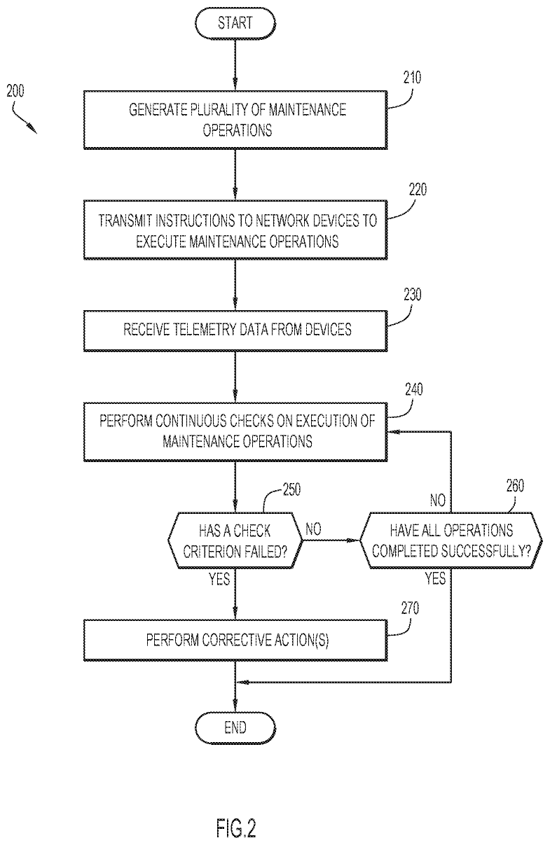

Reference is now made to FIG. 2. FIG. 2 is a flow chart depicting a method 200 of performing maintenance operations on network devices, in accordance with an example embodiment.

A plurality of maintenance operations is generated at operation 210. Maintenance operations may be organized into a method of procedure, and can be executed by configuration manager 150 to perform maintenance on devices in a network. Maintenance operations may be generated based on input from an operator (e.g., a user of client device 170), who may specify parameters for various aspects of a method of procedure's maintenance operations. For example, a user may specify which devices are to receive updates, which updates the devices may receive, and the like. A user may specify roles to be assigned various devices, such as by designating a device as a classifier, a router, etc., and configuration manager 150 may automatically generate the one or more maintenance operations to be performed on those devices in order to provide those devices with the functionality necessary to fulfill the designated roles.

Instructions are transmitted to network devices to execute maintenance operations at operation 220. Configuration manager 150 may transmit instructions comprising one or more maintenance operations to each device that is specified in the method of procedure. For example, one or more network devices of devices 105A-105N may receive a set of instructions from configuration manager 150 that include pre-maintenance tasks and maintenance tasks to be executed. Instructions may be accompanied with a schedule of when to execute each maintenance operation.

Telemetry data is received from network devices at operation 230. Each device may send, via telemetry module 130, telemetry data that indicates the status of the device as maintenance operations are performed. Telemetry data may be formatted according to the YANG model or may correspond to the SNMP protocol, CLI format, and/or any other format. Telemetry data may be received by configuration server 140 and stored in database 165.

Continuous checks are performed on the execution of the maintenance operations at operation 240. Monitoring module 155 may perform continuous checks on the execution of a method of procedure by analyzing the received telemetry data to determine whether any maintenance operations have failed a check criterion. Criteria may include any conditions that are indicative of failure of a particular maintenance operation, and may be specified by an operator during generation of the method of procedure. In some embodiments, a number of failures must occur in order for a criterion to be met; for example, a particular write operation may fail a check criterion if the write operation fails three times. Monitoring module 155 may monitor telemetry data from devices that are subject to maintenance operations, as well as devices that should not be affected by maintenance operations. For example, if maintenance is being performed on devices in a particular zone of a network, monitoring module 155 may also monitor telemetry data from devices in other zones of the network, as their telemetry data may reflect failures in the maintenance process. Some indications of failures may be ignored when such indications can be expected; for example, if a device stops transmitting telemetry data, but the device is currently undergoing an expected reboot, monitoring module 155 may ignore any apparent indication of a failure of that device.

Operation 250 determines whether a criterion of a continuous check has failed. If a criterion of a continuous check has failed, corrective actions may be automatically performed. If a maintenance operation passes its associated criteria, monitoring module 155 may continue to perform continuous checks on other operations until all maintenance operations are deemed to be completed successfully at operation 260, at which point the method of procedure is finished.

If telemetry data indicates that a maintenance operation has failed its check criterion, one or more corrective actions may be performed at operation 270. Corrective actions may include restoring a device's software or firmware to a previous version or state, completing maintenance operations to result in a partially completed upgrade or maintenance of a device, pausing execution of a method of procedure and alerting an operator of a failure, and the like.

In some embodiments, when a method of procedure completes successfully or unsuccessfully, a snapshot of the devices affected by the method of procedure may be taken in order to capture the post-maintenance state of the devices. The post-maintenance snapshot may be compared to a previous snapshot that captures the state of the devices prior to execution of the method of procedure in order to identify differences, which can then be presented to a user. For example, a user interface may indicate to a user the versions of software installed on devices before and after execution of a method of procedure.

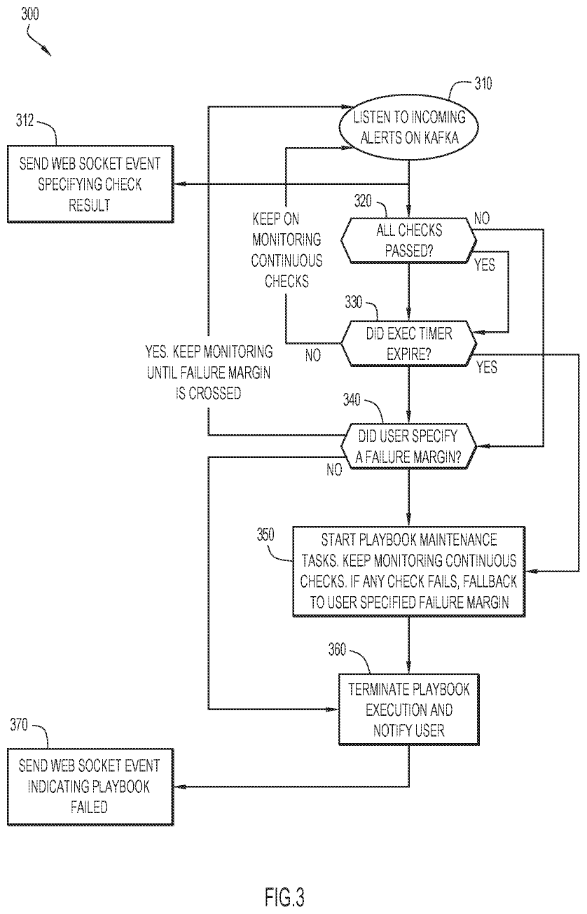

Reference is now made to FIG. 3. FIG. 3 is a flow chart depicting a method 300 of monitoring network devices, in accordance with an example embodiment.

A system may listen to incoming alerts on a messaging bus, such as a Kafka bus, at operation 310. Monitoring module 155 may listen to incoming alerts received from devices in a network, such as devices 105A-105N. Upon execution of operation 310, method 300 may send a web socket event notification to a user interface at operation 312 that specifies one or more check results.

Operation 320 determines whether all check criteria are passed. If so, then method 300 proceeds to operation 330 and determines whether an execution timer has expired. If all checks have not passed, method 300 may proceed to operation 340 to determine whether a user has specified a failure margin.

If it is determined at operation 330 that an execution timer did not expire, then method 300 returns to operation 310 to listen for incoming alerts. If the execution timer has expired, then method 300 proceeds to operation 350, and playbook maintenance tasks are initiated. Monitoring of continuous checks may continue, and if any check fails, the operation falls back to a user-specified failure margin.

Operation 340 determines whether a user has specified a failure margin. If the user has specified a failure margin, then method 300 returns to operation 310 and monitoring is continuously performed until a failure margin is crossed. If a user has not specified a failure margin, then method 300 proceeds to operation 360 and execution of the playbook corresponding to the current maintenance operation is terminated, and a user is notified of the termination.

Upon terminating execution of a playbook, a web socket event is sent to a user interface at operation 370 that indicates that the playbook has failed. For example, client device 170 may receive the failure notification so that a user may respond accordingly, such as by re-executing the method of procedure, debugging, and the like.

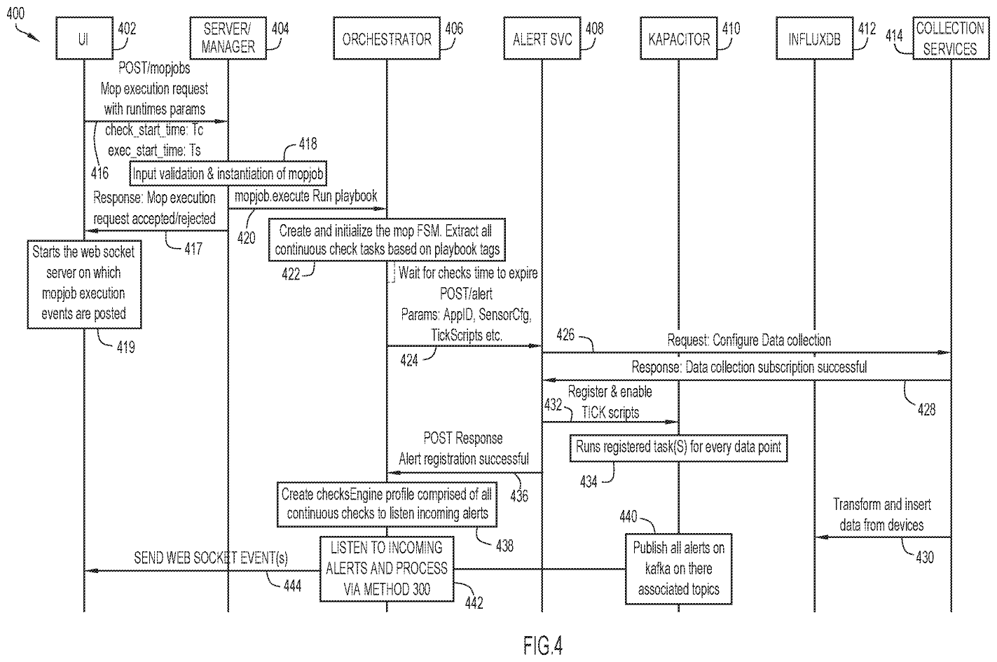

Reference is now made to FIG. 4. FIG. 4 is a sequence diagram depicting an operational flow 400 for monitoring network devices, in accordance with an example embodiment. As depicted, a method of procedure execution request is initiated by an operator at a user interface, and input is validated and the method of procedure job is instantiated by a server. A method of procedure job may include a playbook (e.g., a script for automatically deploying the steps of a method of procedure), parameters for the method of procedure, a failure policy, and scheduling information for execution of the maintenance operations. Collection of configuration data is requested and received. Alerts on Kafka may be published based on their associated topics, and sent to an orchestrator, which may perform aspects of method 300 to process the alerts and send notifications to a user interface.

The operational flow 400 involves interactions between a user interface (UI) 402, server/manager 404, orchestrator 406, alerting server/service (svc) 408, Kapacitor native data processing engine 410 for InfluxDB database 412 and collection services 414. The orchestrator 406 is a service that provides network orchestration functions for network devices 105A-105N, shown in FIG. 2.

A MOP job may be initiated via UI 402, of a client device, such as client device 170. A network operator may interact with UI 402 to send a MOP execution request at 416, which is received by server/manager 404. Server/manager 404 may correspond to configuration server 140 of network environment 100. The MOP execution request may include any runtime parameters provided by a network manager, as well as a schedule of specific times to begin continuous checks and the execution of the MOP job.

Server/manager 404 may perform validation of the received input of the MOP execution request and instantiate a MOP job at operation 418. Server/manager 404 may transmit instructions to an orchestrator 406 to run a playbook of the MOP job, depicted at 420. Server/manager 404 may also transmit a response to UI 402 to indicate whether the MOP execution request has been accepted or rejected, depicted at 417. In response, UI 402 may start a web socket server on which MOP job execution events are posted at operation 419.

Orchestrator 406 may create and initialize a MOP finite state machine (FSM) at operation 422, along with extracting all continuous check operations based on tags in the received playbook information. Orchestrator 406 may transmit instructions to alerting server (service) 408 that include an application identifier (AppID), sensor configuration information (SensorCfg), TICK scripts, and the like, which is shown at 424.

At 426, alerting service 408 may transmit one or more requests to configure data collection to collection services 414, and at 428, alerting service 408 may receive one or more corresponding responses that indicate that the data collection subscription is successful. Collection services 414 may interface with device 105A-105N to collect their telemetry data. At 430, collection services 414 may transmit transformed data from devices, which can be received by database 412 for storage.

Alerting service 408 may register and enable the TICK scripts with Kapacitor 410, depicted at 432. TICK scripts include commands in a domain-specific language that Kapacitor 410 executes to perform extract, transform, and load (ETL) operations on data, such as the collected telemetry data. Kapacitor 410 may run registered tasks for every data points at operation 434.

Alerting service 408 may send a POST response to orchestrator 406 to notify orchestrator 406 that the alert registration was successful, as depicted at 436. At operation 438, orchestrator 406 may create a checksEngine profile that includes all continuous checks (e.g., the checks specified in the MOP job) in order to listen to incoming alerts.

Kapacitor 410 may publish alerts on their associated topics via a Kafka bus at operation 440, which may be received by orchestrator 406 at operation 442 and processed via method 300. The orchestrator 406 may publish web socket events to the UI 401 at operation 444.

Reference is now made to FIG. 5. FIG. 5 is a diagram depicting a user interface screen 500 for performing continuous monitoring, in accordance with an example embodiment. User interface screen 500 may be presented to a user of client device 170 to enable a user to access configuration server 140 and its modules. As depicted, user interface screen 500 includes a search field 510 to select playbooks (e.g., methods of procedure for executing maintenance tasks on network devices), and description information 520 for a selected playbook. The description information may include subfields, such as a description of the continuous monitoring 530 that may be performed, as well as a pre-maintenance tasks 540 and maintenance tasks 550.

Reference is now made to FIG. 6. FIG. 6 is a diagram depicting a user interface screen 600 for a monitoring overview, in accordance with an example embodiment. User interface screen 600 may be presented to a user of client device 170 to enable a user to access configuration server 140 and its modules. As depicted, user interface screen 600 includes an overview 610 of a playbook being executed, including a status 620 of continuous checks, a status 630 of pre-maintenance tasks, and a status 640 of maintenance tasks. An overall status (e.g., “SUCCEEDED”) may also be presented, along with a time stamp. A map 650 may indicate the locations of network devices. Panel 660 may provide detailed log information, which may be grouped according to an events tab, a system log (syslog) tab, and a console tab.

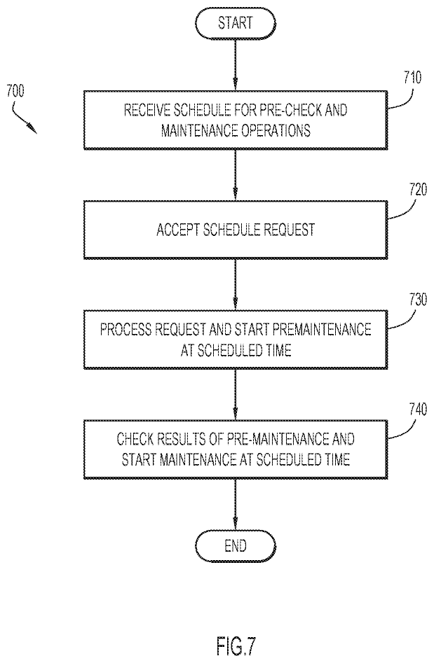

Reference is now made to FIG. 7. FIG. 7 is a flow chart depicting a method 700 of scheduling maintenance operations performed by network devices, in accordance with an example embodiment.

A schedule for pre-check and maintenance operations is received at operation 710. An operator may provide the schedule to configuration manager 150 via administration module 180 of client device 170. The provided information may include a start time for each phase of maintenance, the operations to be performed at each phase of maintenance, including software packages that are to be installed, a selection of the devices that are subject to maintenance, and pass/fail criteria for checks.

The schedule request is accepted at operation 720. Configuration manager 150 may accept the schedule by creating an execution identifier and updating an execution database.

The request is processed and the pre-maintenance phase is started at the scheduled time at operation 730. At the scheduled time, the operations may be executed on one or more network devices of device 105A-105N.

The results of the pre-maintenance phase are checked, and the maintenance phase is started at the scheduled time at operation 740. A check engine of configuration manager 150 may perform checks at scheduled times, and if the checks are passed, then configuration manager 150 may advance to the next stage of maintenance.

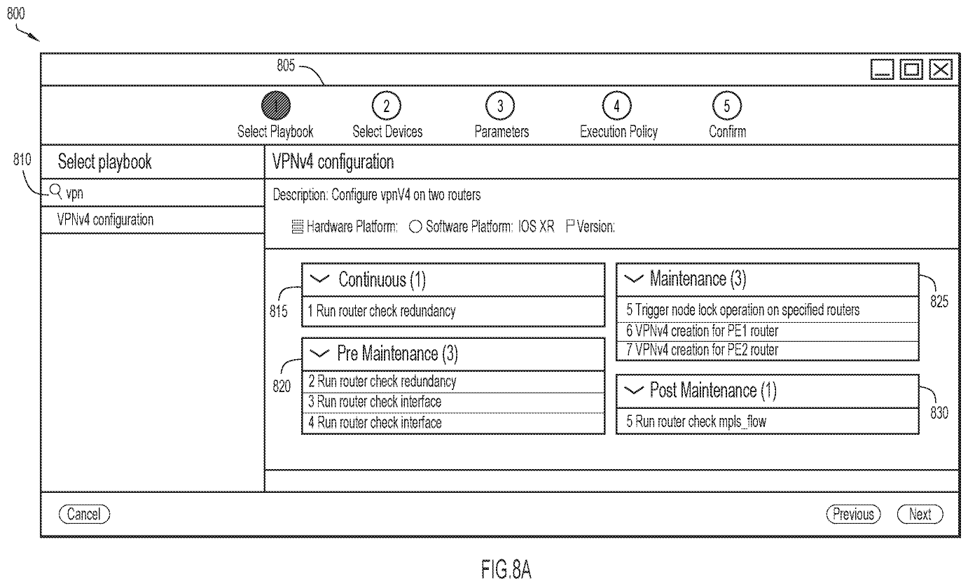

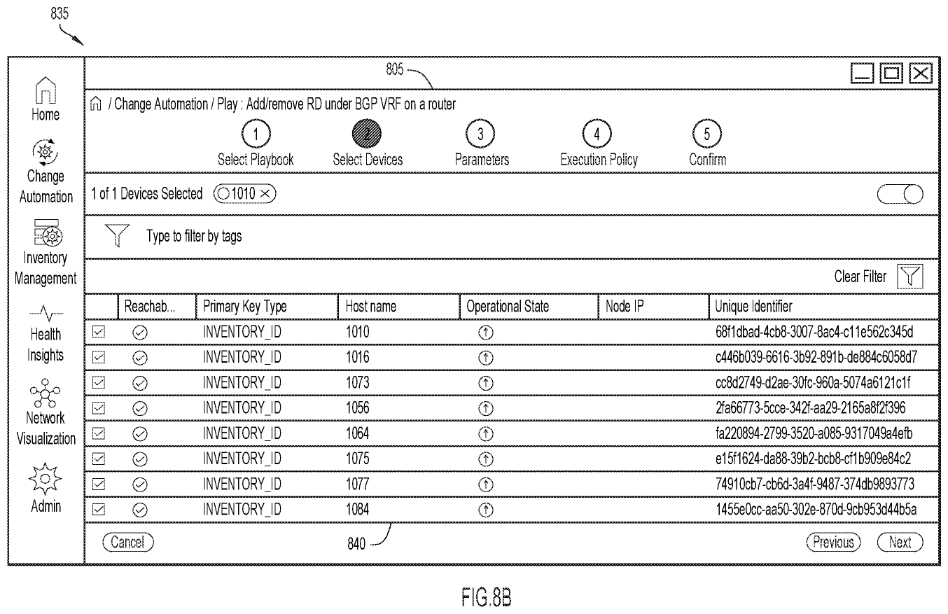

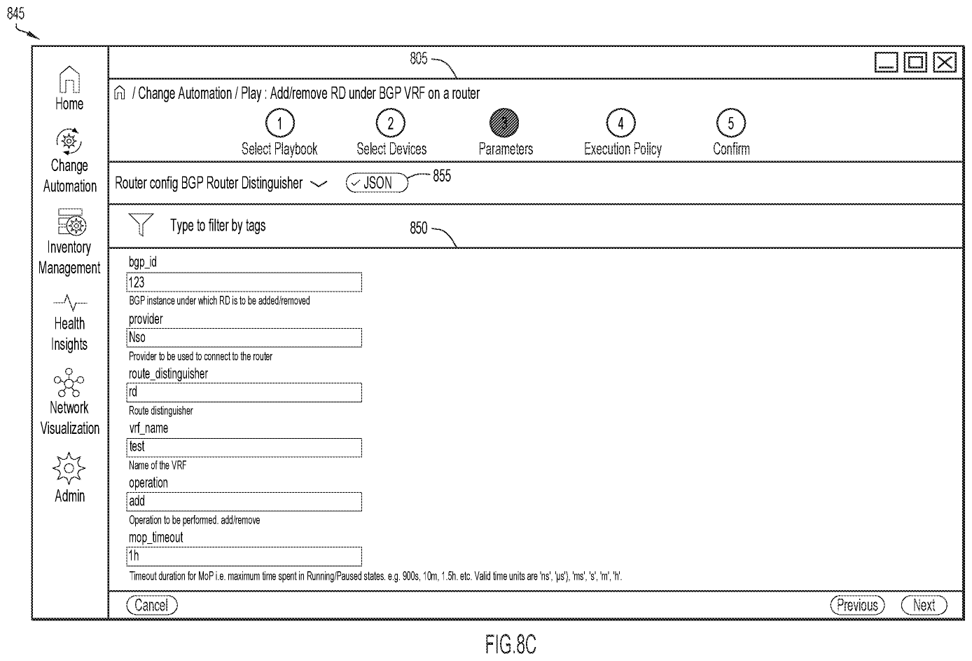

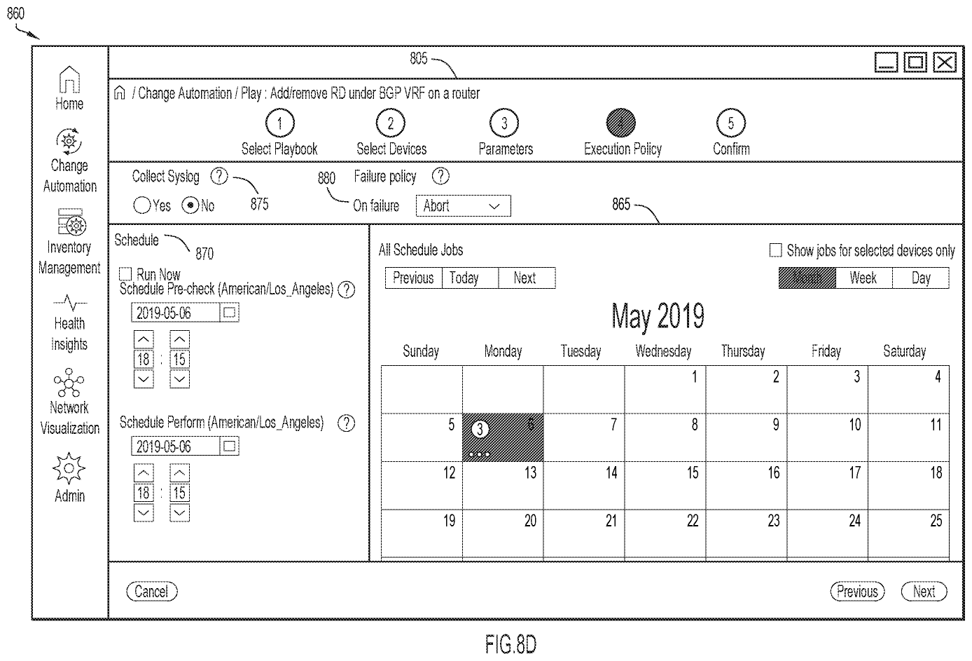

Reference is now made to FIGS. 8A-8D. FIGS. 8A-8D are diagrams depicting user interface screens for scheduling maintenance operations for network devices, in accordance with an example embodiment. An operator may interact with these user interface screens via administration module 180 of client device 170. User interface screen 800 enables an operator to select, via search field 810 a playbook, which is a predefined, configurable sequence of maintenance operations. Overview bar 805 indicates each step of the maintenance process, including a “select playbook” step, a “select devices” step, a “parameters” step, an “execute policy” step, and a “confirm” step. User interface screen 800 shown in FIG. 8A presents a list of tasks per maintenance phase, including continuous checks 815, pre-maintenance tasks 820, maintenance tasks 825, and post-maintenance tasks 830.

An operator may select target devices for maintenance using user interface screen 835. As depicted, user interface screen 835 (FIG. 8B) includes a list of devices 840, which includes key types for each device, host names for each device, operational states for each device, and unique identifiers for each device.

An operator may provide runtime parameters for a playbook via user interface screen 845 (FIG. 8C), which includes fields 850 for specifying various parameters. For example, a user may configure a timeout, route distinguisher, name, and the like, for each device. In some embodiments, an operator may provide runtime parameters using a JavaScript Object Notation (JSON) file, which can be provided via UI element 855.

An operator may schedule checks and maintenance phases via user interface screen 860 (FIG. 8D). As depicted, a maintenance operation may be scheduled for a particular date and time via calendar 865 and scheduler 870. An operator may also indicate whether a system log (i.e., syslog) should be collected via syslog selector 875, and may stipulate the failure policy via failure policy menu 880, which includes operations to be performed in the case that a phase fails a check.

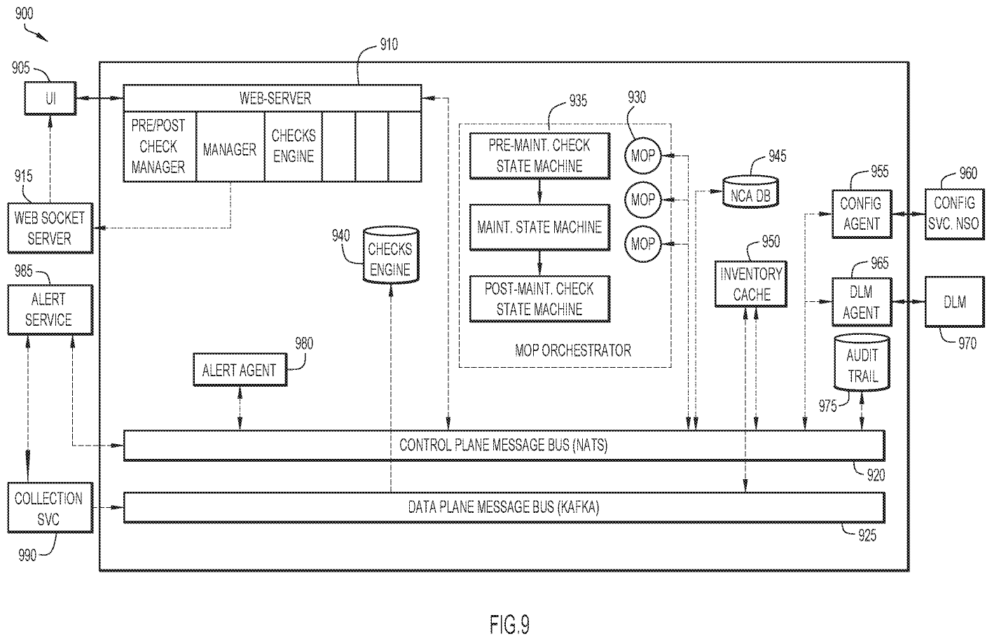

Reference is now made to FIG. 9. FIG. 9 is a block diagram depicting a network maintenance system 900, in accordance with an example embodiment. As depicted, network maintenance system 900 includes a user interface 905 for accessing a web server 910 to control aspects of maintenance operations. Web socket server 915 may receive information from a manager module associated with web server 910 for presentation to the user via user interface 905. Web server 910 may communicate with other components of network maintenance system 900 via a control plane message bus 920. Data plane message bus 925 may be a Kafka bus that enables the exchange of data for alerting purposes.

MOP orchestrator 935 may execute one or more MOPs 930 to perform maintenance tasks. Native cloud architecture (NCA) database 945 stores information such as MOP jobs. Inventory cache 950 may store gathered data that it receives from buses 920 and 925. Configuration agent 955 may communicate with an external configuration service network service orchestrator (NSO) 960 in order to provide relevant data to control plane message bus 920. Data lifecycle manager (DLM) agent 965 receives data from a DLM 970. Data transmitted via control plane message bus 920 may be stored in audit trail 975 for auditing purposes.

A checks engine 940 may analyze data received from data plane messaging bus 925 to perform continuous checks. Alert agent 980, alert service 985, and collection service 990 may issue alerts based on collected data, such as alerts that indicate whether a continuous check has failed.

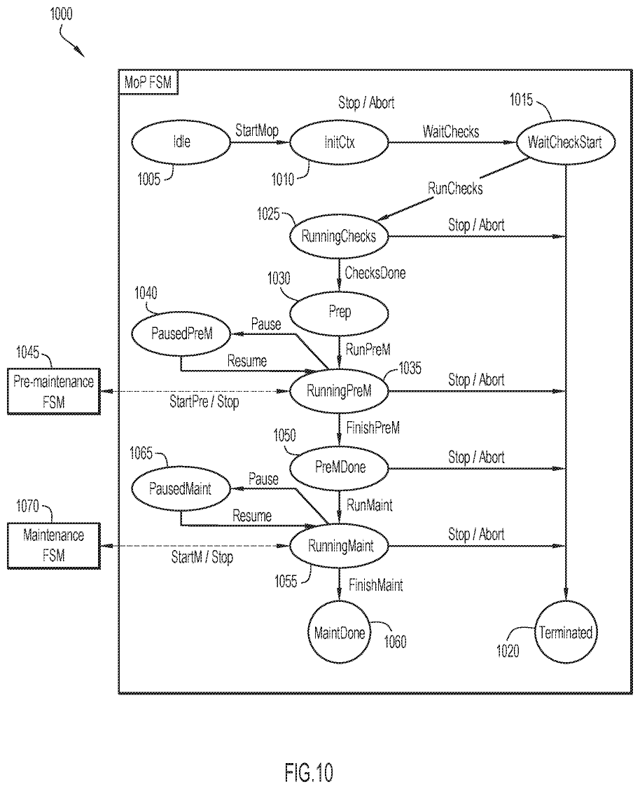

Reference is now made to FIG. 10. FIG. 10 is a diagram depicting a method of performing maintenance using a MOP finite-state machine (FSM) 1000, in accordance with an example embodiment. FSM 1000 may execute a MOP to perform maintenance operations. Beginning at an idle state 1005, the MOP FSM executes an InitCtx command at operation 1010. At operation 1015, a WaitCheckStart command is executed, and initial checks are initiated, which begin execution at operation 1025. These initial checks may determine whether conditions are satisfactory for performing maintenance, such as by ensuring that network devices are online. At operation 1030, MOP FSM prepares for maintenance, and pre-maintenance tasks are performed at operation 1035 using a pre-maintenance FSM 1045. Pre-maintenance tasks may be paused at 1040 if necessary.

Pre-maintenance tasks are finished at operation 1050, and a maintenance FSM 1070 performs maintenance tasks at operation 1055. Maintenance tasks may finish at operation 1060. Maintenance tasks may also be paused if necessary at operation 1065. If any operations are stopped or aborted, either because of an error, failure of a task to satisfy its check criteria, or because a user has manually aborted the maintenance process, the method may terminate at operation 1020.

Reference is now made to FIG. 11. FIG. 11 is a block diagram depicting components of a computer device 1100 suitable for executing the methods disclosed herein. Computer device 1100 may be representative of devices 105A-105N, configuration server 140, and/or client device 170 in accordance with embodiments presented herein. It should be appreciated that FIG. 11 provides only an illustration of one embodiment and does not imply any limitations with regard to the environments in which different embodiments may be implemented. Many modifications to the depicted environment may be made.

As depicted, the computer 1110 includes communications fabric 1112, which provides communications between computer processor(s) 1114, memory 1116, persistent storage 1118, communications unit 1120, and input/output (I/O) interface(s) 1122. Communications fabric 1112 can be implemented with any architecture designed for passing data and/or control information between processors (such as microprocessors, communications and network processors, etc.), system memory, peripheral devices, and any other hardware components within a system. For example, communications fabric 1112 can be implemented with one or more buses.

Memory 1116 and persistent storage 1118 are computer readable storage media. In the depicted embodiment, memory 1116 includes random access memory (RAM) 1124 and cache memory 1126. In general, memory 1116 can include any suitable volatile or non-volatile computer readable storage media. The memory 1116 may store the software instructions for telemetry module 130, configuration manager 150, monitoring module 155, and/or administration module 180 in performing the operations described herein.

One or more programs may be stored in persistent storage 1118 for execution by one or more of the respective computer processors 1114 via one or more memories of memory 1116. The persistent storage 1118 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 1118 may also be removable. For example, a removable hard drive may be used for persistent storage 1118. Other examples include optical and magnetic disks, thumb drives, and smart cards that are inserted into a drive for transfer onto another computer readable storage medium that is also part of persistent storage 1118.

Communications unit 1120, in these examples, provides for communications with other data processing systems or devices. In these examples, communications unit 1120 includes one or more network interface cards. Communications unit 1120 may provide communications through the use of either or both physical and wireless communications links.

I/O interface(s) 1122 allows for input and output of data with other devices that may be connected to computer 10. For example, I/O interface 1122 may provide a connection to external devices 1128 such as a keyboard, keypad, a touch screen, and/or some other suitable input device. External devices 1128 can also include portable computer readable storage media such as, for example, thumb drives, portable optical or magnetic disks, and memory cards.

Software and data used to practice embodiments can be stored on such portable computer readable storage media and can be loaded onto persistent storage 1118 via I/O interface(s) 1122. I/O interface(s) 1122 may also connect to a display 1130. Display 1130 provides a mechanism to display data to a user and may be, for example, a computer monitor.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to continuous monitoring of network devices while executing maintenance operations (e.g., device information, telemetry data, default or custom methods of procedure, scheduling information, failure criteria, software and/or firmware for network devices, etc.) may be stored within any conventional or other data structures (e.g., files, arrays, lists, stacks, queues, records, etc.) and may be stored in any desired storage unit (e.g., database, data or other repositories, queue, etc.). The data transmitted between devices 105A-105N, configuration server 140, and/or client device 170 may include any desired format and arrangement, and may include any quantity of any types of fields of any size to store the data. The definition and data model for any datasets may indicate the overall structure in any desired fashion (e.g., computer-related languages, graphical representation, listing, etc.).

Data relating to continuous monitoring of network devices while executing maintenance operations (e.g., device information, telemetry data, default or custom methods of procedure, scheduling information, failure criteria, software and/or firmware for network devices, etc.) may include any information provided to, or generated by, devices 105A-105N, configuration server 140, and/or client device 170. Data relating to continuous monitoring of network devices while executing maintenance operations may include any desired format and arrangement, and may include any quantity of any types of fields of any size to store any desired data. The data relating to continuous monitoring of network devices while executing maintenance operations may include any data collected about entities by any collection means, any combination of collected information, and any information derived from analyzing collected information.

The present embodiments may employ any number of any type of user interface (e.g., representational state transfer (REST) application programming interfaces (API), Graphical User Interface (GUI), command-line, prompt, etc.) for obtaining or providing information (e.g., data relating to continuous monitoring of network devices), where the interface may include any information arranged in any fashion. The interface may include any number of any types of input or actuation mechanisms (e.g., REST APIs, buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

It will be appreciated that the embodiments described above and illustrated in the drawings represent only a few of the many ways of providing continuous monitoring of network devices while executing maintenance operations.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, PDA, mobile devices, etc.), and may include any commercially available operating system and any combination of commercially available and custom software (e.g., networking software, server software, telemetry module 130, configuration manager 150, monitoring module 155, administration module 180, etc.). These systems may include any types of monitors and input devices (e.g., keyboard, mouse, voice recognition, etc.) to enter and/or view information.

It is to be understood that the software (e.g., networking software, server software, telemetry module 130, configuration manager 150, monitoring module 155, administration module 180, etc.) of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments (e.g., networking software, server software, telemetry module 130, configuration manager 150, monitoring module 155, administration module 180, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the presented embodiments.

The communication network may be implemented by any number of any type of communications network (e.g., LAN, WAN, Internet, Intranet, VPN, etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to continuous monitoring of network devices while executing maintenance operations). The database system may be implemented by any number of any conventional or other databases, data stores or storage structures (e.g., files, databases, data structures, data or other repositories, etc.) to store information (e.g., data relating to continuous monitoring of network devices while executing maintenance operations). The database system may be included within or coupled to the server and/or client systems. The database systems and/or storage structures may be remote from or local to the computer or other processing systems, and may store any desired data (e.g., data relating to continuous monitoring of network devices while executing maintenance operations).

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the present embodiments in the form disclosed. Many modifications and variations will be apparent to those of ordinary skill in the art without departing from the scope and spirit of the presented embodiments. The embodiment was chosen and described in order to best explain the principles of the presented embodiments and the practical application, and to enable others of ordinary skill in the art to understand various embodiments with various modifications as are suited to the particular use contemplated.

The descriptions of the various embodiments of the present embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of the presented embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, RAM, ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Aspects of the present embodiments are described herein with reference to flowchart illustrations and/or block diagrams of methods, apparatus (systems), and computer program products according to presented embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various presented embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one form, a computer-implemented method is provided comprising: generating a plurality of maintenance operations to be executed on a plurality of network devices in a network, transmitting instructions to the plurality of network devices to execute one or more maintenance operations of the plurality of maintenance operations, performing continuous checks on execution of the one or more maintenance operations by analyzing telemetry data received from the plurality of network devices, and automatically performing one or more corrective actions in response to an indication of a network device failing a criterion of a continuous check.

In one form, each maintenance operation may include one of: a pre-maintenance task, and a maintenance task. In another form, the transmitted instructions to execute one or more maintenance operations further include instructions to perform one or more pre-maintenance tasks on a network device, and in response to determining that the network device successfully completed the one or more pre-maintenance tasks, transitioning the network device into a maintenance state and performing, by the network device, one or more maintenance tasks. In a form in which pre-maintenance tasks must be passed prior to executing the maintenance tasks, multiple iterations of the one or more pre-maintenance tasks may be performed to ensure stability before performing the one or more maintenance tasks.

In one form, the one or more corrective actions that are performed on a network device include restoring software of the network device to a state prior to the one or more maintenance operations. In another form, the one or more corrective actions include partially upgrading the network device.

In another form, the computer-implemented method further includes instructions for comparing a post-maintenance state of the plurality of network devices to a pre-maintenance state of the devices to identify differences, and indicating the identified differences to a user.

In another form, an apparatus is provided comprising: a communication interface configured to enable network communications; one or more computer processors; one or more computer readable storage media; program instructions stored on the one or more computer readable storage media for execution by at least one of the one or more computer processors, that when executed by the one or more computer processors, cause the one or more computer processors to: generate a plurality of maintenance operations to be executed on a plurality of network devices in a network, transmit instructions to the plurality of network devices to execute one or more maintenance operations of the plurality of maintenance operations, perform continuous checks on execution of the one or more maintenance operations by analyzing telemetry data received from the plurality of network devices, and automatically perform one or more corrective actions in response to an indication of a network device failing a criterion of a continuous check.

In another form, one or more non-transitory computer readable storage media are provided that are encoded with instructions that, when executed by one or more processors, cause the one or more processors to: generate a plurality of maintenance operations to be executed on a plurality of network devices in a network, transmit instructions to the plurality of network devices to execute one or more maintenance operations of the plurality of maintenance operations, perform continuous checks on execution of the one or more maintenance operations by analyzing telemetry data received from the plurality of network devices, and automatically perform one or more corrective actions in response to an indication of a network device failing a criterion of a continuous check.

In summary, the techniques presented herein provide for the fully-automated execution of a MOP on a plurality of network devices. Multiple data sources can be leveraged in a data source-agnostic manner to perform checks and validations on devices, which may be executed continuously in the background while maintenance operations are executed. Moreover, devices and networks may be monitored to ensure that the maintenance being performed does not have any unintended side-effects. Failure conditions can be specified so that corrective actions are automatically performed in response to errors, enabling for automated MOP execution as a closed-loop system.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a plurality of maintenance operations to be executed on a plurality of network devices in a network;
transmitting instructions to the plurality of network devices to execute one or more maintenance operations of the plurality of maintenance operations;
performing continuous checks on execution of the one or more maintenance operations by analyzing telemetry data received from the plurality of network devices; and
automatically performing one or more corrective actions in response to an indication of a network device failing a criterion of a continuous check.

2. The computer-implemented method of claim 1, wherein each maintenance operation includes one of: a pre-maintenance task, and a maintenance task.

3. The computer-implemented method of claim 2, wherein the transmitted instructions to execute one or more maintenance operations further comprise instructions to:
perform one or more pre-maintenance tasks on a network device; and
in response to determining that the network device successfully completed the one or more pre-maintenance tasks, transitioning the network device into a maintenance state and performing, by the network device, one or more maintenance tasks.

4. The computer-implemented method of claim 3, wherein multiple iterations of the one or more pre-maintenance tasks are performed to ensure stability before performing the one or more maintenance tasks.

5. The computer-implemented method of claim 1, wherein the one or more corrective actions performed on a network device include restoring software of the network device to a state prior to the one or more maintenance operations.

6. The computer-implemented method of claim 1, wherein the one or more corrective actions performed on a network device include partially upgrading the network device.

7. The computer-implemented method of claim 1, wherein the plurality of maintenance operations are scheduled to be executed at specified times.

8. The computer-implemented method of claim 1, further comprising:
comparing a post-maintenance state of the plurality of network devices to a pre-maintenance state of the plurality of network devices to identify differences; and
indicating the differences to a user.

9. An apparatus comprising:
a communication interface configured to enable network communications;
one or more computer processors;
one or more computer readable storage media;
program instructions stored on the one or more computer readable storage media for execution by at least one of the one or more computer processors, that when executed by the one or more computer processors, cause the one or more computer processors to:
generate a plurality of maintenance operations to be executed on a plurality of network devices in a network;
transmit instructions to the plurality of network devices to execute one or more maintenance operations of the plurality of maintenance operations;
perform continuous checks on execution of the one or more maintenance operations by analyzing telemetry data received from the plurality of network devices; and
automatically perform one or more corrective actions in response to an indication of a network device failing a criterion of a continuous check.

10. The apparatus of claim 9, wherein each maintenance operation includes one of: a pre-maintenance task, and a maintenance task.

11. The apparatus of claim 9, wherein the instructions to execute one or more maintenance operations further comprise instructions to:
perform one or more pre-maintenance tasks on a network device; and
in response to determining that the network device successfully completed the one or more pre-maintenance tasks, transition the network device into a maintenance state and perform, by the network device, one or more maintenance tasks.

12. The apparatus of claim 9, wherein the program instructions to automatically perform one or more corrective actions include instructions to restore software of a network device, of the plurality of network devices, to a state prior to the one or more maintenance operations.

13. The apparatus of claim 9, wherein program instructions to automatically perform one or more corrective actions include instructions to partially upgrade a network device of the plurality of network devices.

14. The apparatus of claim 9, wherein the plurality of maintenance operations are scheduled to be executed at specified times.

15. One or more non-transitory computer readable storage media encoded with instructions that, when executed by one or more processors, cause the one or more processors to:
generate a plurality of maintenance operations to be executed on a plurality of network devices in a network;
transmit instructions to the plurality of network devices to execute one or more maintenance operations of the plurality of maintenance operations;
perform continuous checks on execution of the one or more maintenance operations by analyzing telemetry data received from the plurality of network devices; and
automatically perform one or more corrective actions in response to an indication of a network device failing a criterion of a continuous check.

16. The one or more non-transitory computer readable storage media of claim 15, wherein each maintenance operation includes one of: a pre-maintenance task, and a maintenance task.

17. The one or more non-transitory computer readable storage media of claim 15, wherein the instructions to execute one or more maintenance operations further comprise instructions to:
perform one or more pre-maintenance tasks on a network device; and
in response to determining that the network device successfully completed the one or more pre-maintenance tasks, transition the network device into a maintenance state and perform, by the network device, one or more maintenance tasks.

18. The one or more non-transitory computer readable storage media of claim 15, wherein the instructions to automatically perform one or more corrective actions include instructions to restore software of a network device, of the plurality of network devices, to a state prior to the one or more maintenance operations.

19. The a one or more non-transitory computer readable storage media of claim 15, wherein the instructions to automatically perform one or more corrective actions on include instructions to partially upgrade a network device, of the plurality of network devices.

20. The one or more non-transitory computer readable storage media of claim 15, wherein the plurality of maintenance operations are scheduled to be executed at specified times.
